(19) United States
(12) Patent Application Publication
(10) Pub. No.: US 2015/0352009 A1
(43) Pub. Date: Dec. 10, 2015

(54) USER-SPECIFIC PILL DISPENSARY, PACKAGE, SYSTEM, AND METHODS RELATING TO SAME

(71) Applicant: Sarah E. Miller, Freeland, MD (US)

(72) Inventor: Sarah E. Miller, Freeland, MD (US)

(21) Appl. No.: 14/295,462

(22) Filed: Jun. 4, 2014

(51) Int. Cl. A61J 1/03; B65B 61/02; B65B 5/08; B65D 75/36; B65D 65/14

(52) U.S. Cl. CPC A61J 1/035; B65D 75/367; B65D 65/14; B65B 5/08; B65B 61/025; A61J 2205/50

(57) ABSTRACT

A user-specific pill dispensary, system, and methods related to same are provided. The user-specific pill dispensary includes a blister sheet having an array of cavities configured to each hold one or more pills. The dispensary also includes a backing having a graphical framework and plural cavity-specific-temporal indicia to organize one or more user-specific pills in the calendar format for ease of dispensing and consumption by the user. The cavities can be filled, e.g., by a pharmacy or other entity, based on the requirements of a user, such as the medications requirements of a patient. Therefore, as an example, the user can be a patient and the pills can be or include medications such as prescription drugs, as examples. Once filled, the backing can be applied to the blister sheet to seal the pills in their respective cavities.

### BACKGROUND

Inventive concepts relate to delivery of pills and, more particularly, to personalized packaging, organizing, and delivery of pills, e.g., medications (including prescriptions) to individuals, including capsules, tablets, and the like.

Taking medications, including prescribed medications, in the proper amount, on the proper day, and at the proper time can be a confusing task, which, if improperly executed, can have serious negative consequences. Even the seemingly trivial task of remembering at some point in the day whether a medication has been taken or not can be trying, particularly to a patient dealing with multiple prescriptions, and even more so if the medications are to be taken at different times of the day. Additionally, if the patient, due to her illness or as a side effect of her medications, is somewhat confused, forgetful, or otherwise debilitated by her condition, the possibility of dire consequences are multiplied.

An apparatus, system, device, and method which provides a user, such as a patient, with assistance in taking her, or his, medications in the proper amount on the proper day and at the proper time may be a significant improvement in healthcare delivery. The foregoing would also be useful to caregivers, whether professional nurses or family members, or others, assisting individuals taking medications. Additionally or alternatively, individuals taking non-medicating pills, capsules, and the like may benefit from such a system, device, and method.

### SUMMARY OF THE INVENTION

In accordance with the inventive concepts, there is provided a personalized or user-specific pill dispensary that organizes multiple pills (e.g., medications) for the individual in one easy-to-use package. The dispensary can include an array of cavities, or the like, each formed to hold one or more pills, e.g., medications. A backing or other layer of the dispensary can provide a graphical framework in a calendar format, e.g., a week or month, which organizes the pills stored therein. Pills can be temporally organized according to their dosage and usage requirements, so that the calendar format indicates the day and time of day pills are to be taken. For example, if two pills are contained in a single cavity under a Tuesday column of the calendar format and the cavity is labeled “morning” or “a.m.”, the individual knows to take the pills in that cavity on Tuesday morning. Other medications can be contained and labeled in a similar manner, providing ease of dispensing and consumption for the patient. Such a dispensary also makes it clear if a user has skipped or missed a dosage, since the missed cavity will remain unused and full.

In accordance with one aspect of the inventive concepts, provided is a user-specific pill dispensary. The dispensary comprises a blister sheet having an array of cavities formed therein, including cavities formed to contain user-specific pills and a backing configured to seal the array of cavities. The backing includes a graphical framework that organizes the array of cavities into a calendar format having plural cavity-specific-temporal indicia within a single calendar day for one or more days represented by the calendar format. The graphical framework and plural cavity-specific-temporal indicia organize the one or more user-specific pills in the calendar format for ease of dispensing and consumption. The user can be a patient and the pills can be or include medications.

In various embodiments, one or more of the cavities can be formed to hold more than one pill in an individual cavity having the same cavity-specific-temporal indicia.

In various embodiments, the backing can be a foil-back sheet including an adhesive that mates with an open back of the blister sheet.

In various embodiments, the calendar format can represent a single week or a single month, or other dosage period.

In various embodiments, the calendar format can include a plurality of day fields, which can optionally be arranged in columns.

In various embodiments, the plural cavity-specific-temporal indicia can include at least two different time-of-day indicia.

In various embodiments, the at least two different time-of-day indicia can include two or more of a.m., morning, noon, afternoon, p.m., evening, bedtime, breakfast, snack, lunch, and dinner.

In various embodiments, each of the at least two time-of-day indicia can have a different visual appearance.

In various embodiments, the different visual appearance can include, for each different time-of-day indicia: color coding; different shapes; different patterns; or combinations of two or more of the above.

In various embodiments, the calendar format can be viewable through the blister sheet.

In various embodiments, the calendar format can be viewable from a rear face or open back of the backing, opposite the blister sheet.

In various embodiments, the backing can further include pill (e.g., medication) information for one or more pills contained within a cavity of the blister sheet. The pill information can include: a graphical representation of the one or more pills; a dosage amount of the one or more pills; or a graphical representation and a dosage amount of the one or more pills.

In various embodiments, the pill information can further include one or more of: side effect information for the one or more pills; warnings for the one or more pills; usage instructions for the one or more pills; or combinations of two or more of thereof.

In various embodiments, the backing can further include user-specific information, where the user can be a patient. The user-specific information can include: a user patient name; a user address; a user identification number; a user date of birth; user allergy information; user aliment or condition information; emergency contact information; user medical insurance information; prescribing physician information, if any; dispensing pharmacy information, if any; or combinations of two or more of the above.

In various embodiments, the backing can include a user-specific printable label on which the graphical framework is electronically printed.

In various embodiments, the blister sheet can include at least one alignment protrusion or recess/cutout and the backing can include at least one corresponding alignment recess/cutout or protrusion to provide a predetermined mating of the backing with the blister sheet.

In accordance with another aspect of the inventive concepts, provided is a user-specific pill dispensary. The dispensary comprises a blister sheet having an array of cavities formed therein, each cavity containing one or more user-specific medication, at least one cavity containing a plurality of pills having common temporal indicia. The dispensary further comprises a backing sealing the array of cavities, the backing including a graphical framework that organizes the array of cavities into a calendar format having plural cavity-specific-temporal indicia within a single calendar day for one or more days represented by the calendar format. The graphical framework and plural cavity-specific-temporal indicia organize the one or more user-specific pills (e.g., medications) in the calendar format for ease of dispensing and consumption by the user (e.g., patient).

In various embodiments, the plural cavity-specific-temporal indicia can include at least two different time-of-day indicia, including two or more of a.m., morning, noon, afternoon, p.m., evening, bedtime, breakfast, snack, lunch, and dinner.

In various embodiments, each of the at least two time-of-day indicia can have a different visual appearance, including for each different time-of-day indicia: color coding; different shapes; different patterns; or combinations of two or more thereof.

In various embodiments, the blister sheet can include at least one alignment protrusion or recess/cutout and the backing can include at least one corresponding alignment recess/cutout or protrusion to ensure a predetermined mating of the backing with the blister sheet.

In accordance with another aspect of the inventive concepts, provided is a method of preparing a user-specific pill dispensary, e.g., a patient-specific medications dispensary. The method comprises a first step of providing a blister sheet having an array of cavities formed therein, each cavity formed to receive one or more user-specific pills. Another step includes preparing a backing configured to seal the array of cavities, including printing the backing to include a graphical framework that organizes the array of cavities into a calendar format having plural cavity-specific-temporal indicia within a single calendar day for one or more days represented by the calendar format. Another step includes filling the array of cavities with the one or more user-specific pills (e.g., medications) according to the calendar format and the cavity-specific-temporal indicia. And, yet another step includes applying the backing to the blister sheet to seal the array of cavities and transform the blister sheet into a sealed pill dispensary having the one or more pills organized according to the calendar format and the cavity-specific temporal indicia. The graphical framework and plural cavity-specific-temporal indicia organize the one or more user-specific pills (e.g., medications) in the calendar format for ease of dispensing and consumption by the user (e.g., patient).

In various embodiments, the plural cavity-specific-temporal indicia can include at least two different time-of-day indicia including two or more of a.m., morning, noon, afternoon, p.m., evening, bedtime, breakfast, snack, lunch, and dinner.

In various embodiments, each of the at least two time-of-day indicia can have a different visual appearance, including for each different time-of-day indicia: color coding; different shapes; different patterns; or combinations of two or more of the above.

In various embodiments of the method, one or more of the cavities can be configured to individually hold plural pills (e.g., medications) having the same temporal indicia.

In various embodiments, the method can include forming the blister sheet to include at least one alignment protrusion or recess/cutout and forming the backing to include at least one corresponding alignment recess/cutout or protrusion configured to mate, to ensure a predetermined mating of the backing with the blister sheet.

In accordance with another aspect of the inventive concepts, provided is a pill dispensary kit. The kit comprises a blister sheet having an array of cavities formed therein, each cavity containing one or more user-specific pill, at least one cavity formed to contain one or more of a plurality of pills. The kit further comprises a backing configured to seal the array of cavities. The backing includes or takes the form of a printable label on which can be printed, for a specific user, a graphical framework that organizes the array of cavities into a calendar format having plural cavity-specific-temporal indicia within a single calendar day for one or more days represented by the calendar format. The graphical framework and plural cavity-specific-temporal indicia organize the one or more user-specific pills (e.g., medications) in the calendar format for ease of dispensing and consumption by the user (e.g., patient).

In various embodiments, the plural cavity-specific-temporal indicia can include at least two different time-of-day indicia, including two or more of a.m., morning, noon, afternoon, p.m., evening, bedtime, breakfast, snack, lunch, and dinner.

In various embodiments, each of the at least two time-of-day indicia can have a different visual appearance, including for each different time-of-day indicia: color coding; different shapes; different patterns; or combinations of two or more of the above.

In various embodiments of the dispensary, one or more of the cavities can be configured to individually hold plural pills (e.g., medications).

In various embodiments, the blister sheet can include at least one alignment protrusion or recess/cutout and the backing can include at least one corresponding alignment recess/cutout or protrusion configured to mate to ensure a predetermined mating of the backing with the blister sheet.

In accordance with another aspect of inventive concepts, provided is a method of generating a medications dispensary backing that mates with a blister sheet having formed therein an array of medication cavities. The method includes a processor receiving medication-dispensing information for a patient, including dosage and consumption information for one or more medications. The method further includes the processor generating a backing design having a graphical framework that organizes the array of cavities into a calendar format having multiple cavity-specific-temporal indicia within a single calendar day for one or more days represented by the calendar format, which embodies the dosage and temporal consumption information for the medications. And the method includes electronically printing at least a portion of the backing including the multiple cavity-specific-temporal indicia.

In various embodiments, one or more of the cavities is formed to individually hold plural medications having the same cavity-specific-temporal indicia.

In various embodiments, printing at least a portion of the backing can include printing a label that forms at least a portion or layer of the backing, the label including the multiple cavity-specific-temporal indicia.

In various embodiments, the backing includes a printable foil-back sheet having an adhesive to facilitate mating with the blister sheet.

In various embodiments, the temporal consumption information can include a duration of a prescription.

In various embodiments, the calendar format can represent a single week or a single month.

In various embodiments, the calendar format can include a plurality of day fields arranged in columns.

In various embodiments, electronically printing at least a portion of the backing can include printing images of pills representing the medications filling the cavities, according to the medication-dispensing information.

In various embodiments, the method can include mating the backing to an open back of the blister sheet, thereby sealing the medications within the array of cavities, including aligning the backing design with corresponding cavities of the blister sheet.

In various embodiments, the blister sheet can include at least one alignment protrusion or recess/cutout and the backing can include at least one corresponding alignment recess/cutout or protrusion so that the mating ensures a predetermined aligning of the backing design with corresponding cavities of the blister sheet.

In various embodiments, the printed cavity-specific-temporal information includes an array of time-of-day codes arranged within a day field of the calendar format.

In various embodiments, the design includes printed medication information that includes a graphical representation of one or more medications contained within the array of cavities of the blister sheet.

In various embodiments, the printed medication information can include a dosage associated with the graphically-represented one or more medications.

In various embodiments, user-specific information, can include: a patient name; a patient address; a patient identification number; a patient date of birth; patient allergy information; patient aliment or condition information; emergency contact information; patient medical insurance information; prescribing physician information; dispensing pharmacy information; or combinations of two or more thereof.

In accordance with another aspect of the inventive concepts, provided is a method of providing a patient-specific pill dispensary. The method includes receiving at a medication processor, patient medication dispensing information; printing a label according to a patient-tailored medication dispensing plan developed from the patient medication dispensing information; placing medication according the patient-tailored medication dispensing plan in cavities of a blister sheet having an array of cavities; and adhering the label to the blister sheet to form a patient-tailored medication dispensing blister package.

In various embodiments, the step of printing the label includes printing plural cavity-specific-temporal indicia arranged within day-fields of a calendar format.

In various embodiments, the step of printing the plural cavity-specific-temporal indicia includes printing at least two different time-of-day indicia, including two or more of a.m., morning, noon, afternoon, p.m., evening, bedtime, breakfast, snack, lunch, and dinner.

In various embodiments, each of the at least two time-of-day indicia has a different visual appearance.

In various embodiments, the different visual appearances can include, for each different time-of-day indicia: color coding; different shapes; different patterns; or combinations of two or more of the above.

### BRIEF DESCRIPTION OF THE DRAWINGS

Aspects of inventive concepts will be more clearly understood from the following detailed description taken in conjunction with the accompanying drawings, in which:

FIG. 1A is an embodiment of a user-specific pill dispensary, in accordance with principles of the inventive concepts;

FIG. 1B is an embodiment of an adhesive side of a backing of the user-specific pill dispensary, in accordance with principles of the inventive concepts;

FIG. 1C is an embodiment of a label side of the backing of the user-specific pill dispensary, in accordance with principles of the inventive concepts;

FIG. 1D is an embodiment of a set of time-of-day codes of a label side of the backing of the user-specific pill dispensary, in accordance with principles of the inventive concepts;

FIG. 2A is an embodiment of a cavity array, such as a blister sheet, that may be mated with the baking to form a user-specific pill dispensary, such as that of FIG. 1A, in accordance with principles of the inventive concepts;

FIG. 2B is an embodiment of a blister sheet loading template, in accordance with principles of the inventive concepts;

FIGS. 3A and 3B are partial side views of a user-specific pill dispensary, in accordance with principles of the inventive concepts;

FIG. 4 is another embodiment of a backing of user-specific pill dispensary, in accordance with principles of the inventive concepts;

FIG. 5 is a block diagram of an embodiment of a processing system which may be employed in the processing of user-specific pill dispensary information and backing content design and generation, in accordance with principles of the inventive concepts; and

FIG. 6 is a flowchart illustrating an embodiment of a method of providing a user-specific pill dispensary, in accordance with principles of the inventive concepts.

### DETAILED DESCRIPTION

Exemplary embodiments in accordance with principles of inventive concepts will now be described more fully with reference to the accompanying drawings, in which exemplary embodiments are shown. The principles of inventive concept may, however, be embodied in many different forms and should not be construed as being limited to the embodiments set forth herein. Like reference numerals in the drawings denote like elements, and thus their description may not be repeated.

It will be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present. As used herein the term “and/or” includes any and all combinations of one or more of the associated listed items. Other words used to describe the relationship between elements should be interpreted in a like fashion (for example, “between” versus “directly between,” “adjacent” versus “directly adjacent,” “on” versus “directly on”). The word “or” is used in an inclusive sense, unless otherwise indicated.

It will be understood that, although the terms “first,” “second,” etc. may be used herein to describe various elements, components, regions, layers and/or sections, these elements, components, regions, layers and/or sections should not be limited by these terms. These terms are only used to distinguish one element, component, region, layer or section from another element, component, region, layer or section. Thus, a first element, component, region, layer or section discussed below could be termed a second element, component, region, layer or section without departing from the teachings of exemplary embodiments.

Spatially relative terms, such as “beneath,” “below,” “lower,” “above,” “upper” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if an element in the figures is turned over, elements described as “bottom,” “below,” “lower,” or “beneath” other elements or features would then be oriented “atop,” or “above,” the other elements or features. Thus, the exemplary terms “bottom,” or “below” can encompass both an orientation of above and below, top and bottom. The device may be otherwise oriented (rotated 90 degrees or at other orientations) and the spatially relative descriptors used herein interpreted accordingly.

The terminology used herein is for the purpose of describing particular embodiments only and is not intended to be limiting of exemplary embodiments. As used herein, the singular forms “a,” “an” and “the” are intended to include the plural forms as well, unless the context clearly indicates otherwise. It will be further understood that the terms “comprises”, “comprising”, “includes” and/or “including,” if used herein, specify the presence of stated features, integers, steps, operations, elements and/or components, but do not preclude the presence or addition of one or more other features, integers, steps, operations, elements, components and/or groups thereof.

In exemplary embodiments in accordance with principles of the inventive concepts, a user-specific pill dispensary and methods relating to same are provided. As used herein, the term “pills” can include medications, such as prescription or over-the-counter drugs, vitamins, supplements, and the like in various forms; such forms can include tablets, gel caps, capsules, lozenges, as examples. However, in some embodiments, the term “pills” may broadly encompass powders, liquids, crystals, herbs, or other forms of substances dosed out—particularly, but not exclusively, for health improvement or treatment purposes.

The dispensary includes separated compartments for organizing and storing a user's pills, e.g., medications, prescriptions, vitamins, and so on, according to consumption instructions, patterns, and/or requirements, e.g., at the appropriate day, date, time, and in the appropriate quantity. Each compartment may hold one or more pills, wherein pills stored in the same compartment are to be taken at or about the same time, i.e., same day and time of day.

Generally herein, the term “user” can be used to refer to a user, such as a patient, that receives a pill dispensary in accordance with principles of inventive concepts, but users need not be under the care of a physician, as the term “patient” might imply. Beyond patients under a physician's care, in a more general case, a user may be any user that receives a user-specific pill dispensary containing a specific regime of vitamins, supplements, or over-the-counter medications, as examples, whether or not prescribed by a medical professional.

In exemplary embodiments, the pill dispensary can take the form of a “blister” package, or a similar style package. In such cases, pills can be provided in separated compartments that can take the form of a plurality of depressions, cavities, wells, voids, or “blisters,” as examples, collectively referred to as “cavities” or a “cavity array.” The cavities can be formed in a durable protective sheet, e.g., composed of a thermo-plastic material, which may be referred to as a “blister sheet.” A rear face or open back of the blister sheet may include a plurality of openings corresponding to the cavities formed therein for loading pills into appropriate cavities.

Covering the blister sheet may be a “backing” or “printable backing” that, when applied to the blister sheet, covers and seals the openings used to load pills (e.g., medications) into the blister sheet. The printable backing may be, or include, a printable foil-back sheet, a printed label, or printable plastic sheet, as examples, having at least one side on which can be printed or provided with plural cavity-specific-temporal indicia, e.g., time-of-day codes, within the context of a graphical framework including a calendar formatted portion, which could be pre-printed on a printable sheet.

The backing can be configured to seal the array of cavities, and includes the graphical framework for organizing the array of cavities into the calendar format, e.g., with plural cavity-specific-temporal indicia within a single calendar day for one or more days represented by the calendar format. One or more of the cavities can be configured to individually hold plural pills having the same cavity-specific-temporal indicia, e.g., 2 or 3 medications in the same sealed cavity to be taken on the same day and at the same time. The pills are maintained in the cavities until dispensed by or for the user. Therefore, in accordance with aspects of the present invention, the pill dispensary can be loaded, arranged, and configured for a specific user (or consumer, or patient), e.g., by a pharmacy, drug company, or other entity. Therefore, a user-specific or patient-specific pill package or dispensary can be provided, as well methods for providing or forming same.

In various embodiments, as a user dispenses the pills from the dispensary according to the clearly labeled backing, she receives an immediate multi-sensory indication (visual and tactile) that the pills associated with the blister's (cavity's) day and time have been dispensed. There is also indication if pills (e.g., medications) have been skipped, when cavities have not been opened and pills not used at the prescribed or intended days and times.

The backing can be adhered or otherwise applied to the back of the blister sheet that incorporates the cavities, as mentioned above. The backing can include or be formed of paper, paperboard, plastic, or a metal foil, or may be a layered combination of any of these or other materials, for example. The backing can include an adhesive pattern arranged for mating with a pattern of the plurality of openings of the blister sheet, where the adhesive completely or substantially avoids or omits adhesive on portions of the backing that ultimately close each cavity of the blister sheet—so that the pills inside the cavity preferably do not stick to the adhesive. In other embodiments, the backing can be applied to the blister sheet using other approaches, e.g., adhering or securing one or more ends or edges of the backing to the blister sheet.

The backing may include or be a printable information sheet on which user and/or pill information can be printed, such as patient-specific medication information. Such information may be visible from a back side of the pill dispensary, from a front side of the pill dispensary, or both. The adhesive pattern side may be covered with a layer of material, such as a thin plastic layer, that only lightly adheres to the adhesive so that the backing can be put through a printer for adding the various forms of user-specific pill dispensary information, so the adhesive remains intact through printing. The thin layer can then be removed after printing the information on the backing for application of the backing to an associated blister sheet. In exemplary embodiments, the printed information can provide an identification of the patient and indicia of the day, date, and time of day when the pill(s), e.g., medication(s), contained within an associated cavity is or are to be taken.

In some alternative embodiments, rather than the backing being a single sheet that covers all of the cavities, the backing may comprise a plurality of cavity covers, e.g., where a cavity cover may be sized and constructed to cover a subset of cavities. For example, a cavity cover could cover a single cavity. In other embodiments, a cavity cover could cover 1 week's worth of cavities, as an example. In another embodiment, a cavity cover could cover a row and/or a column of cavities. The invention is not inherently limited in this regard.

The backing may also include user-specific information necessary or useful for correctly dispensing the pills from the dispensary. In exemplary embodiments, the user-specific information can include user name; user address; user identification number; user date of birth; user allergy information; user aliment or condition information; emergency contact information; user medical insurance information, if any; prescribing physician information, if any; dispensing pharmacy information, if any; or combinations of two or more thereof. The user can be a patient taking a set of prescriptions, as an example.

The backing may also include pill (or medication) information necessary or useful for correctly dispensing the pills in the dispensary. The pill information can include indicia of the day, date, and time of day when the pills or medications contained within the cavities are to be taken. The pill information can include: a graphical representation of the one or more pills (e.g., medications) in the pill dispensary; a dosage amount of the one or more pills (e.g., medications) in the pill dispensary; or both. In the case of medications, as an example, drug warnings and consumption instructions may optionally be printed on the backing, as well as information identifying the medications stored in the medications package, i.e., within the cavities.

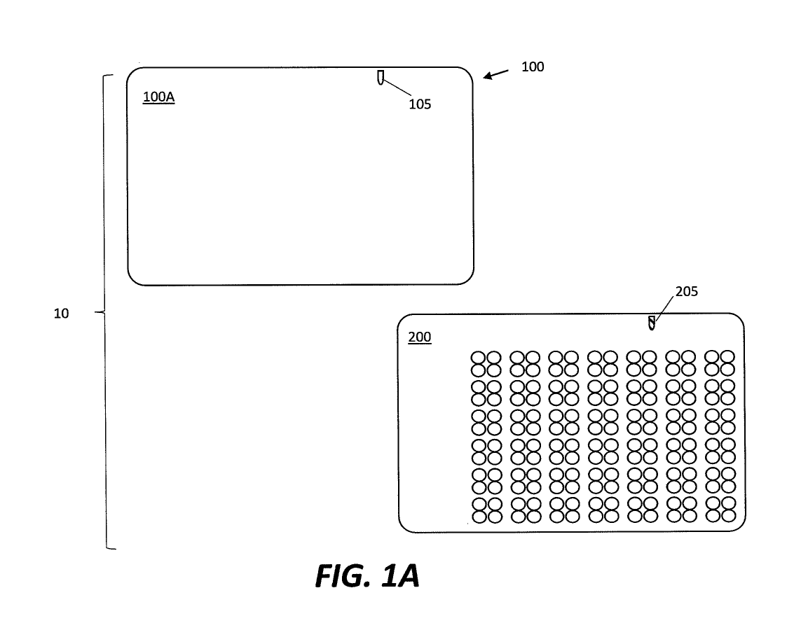

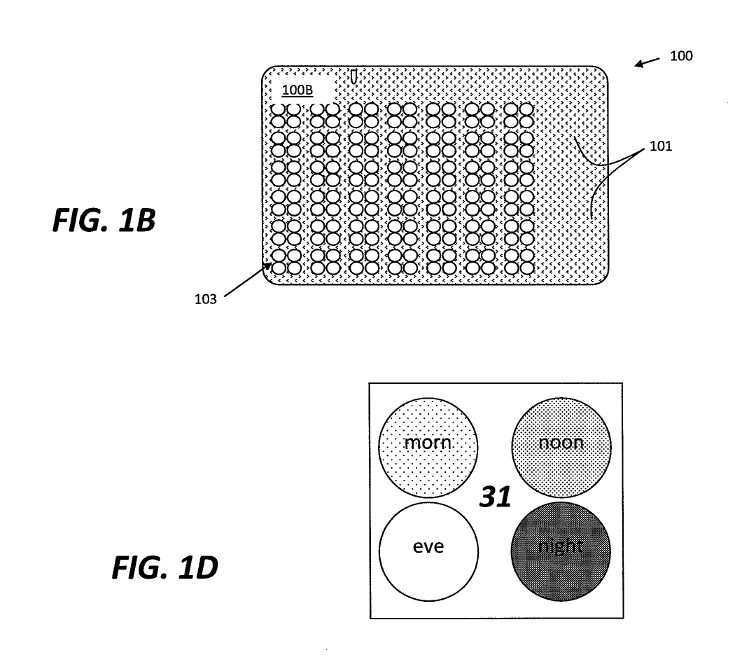

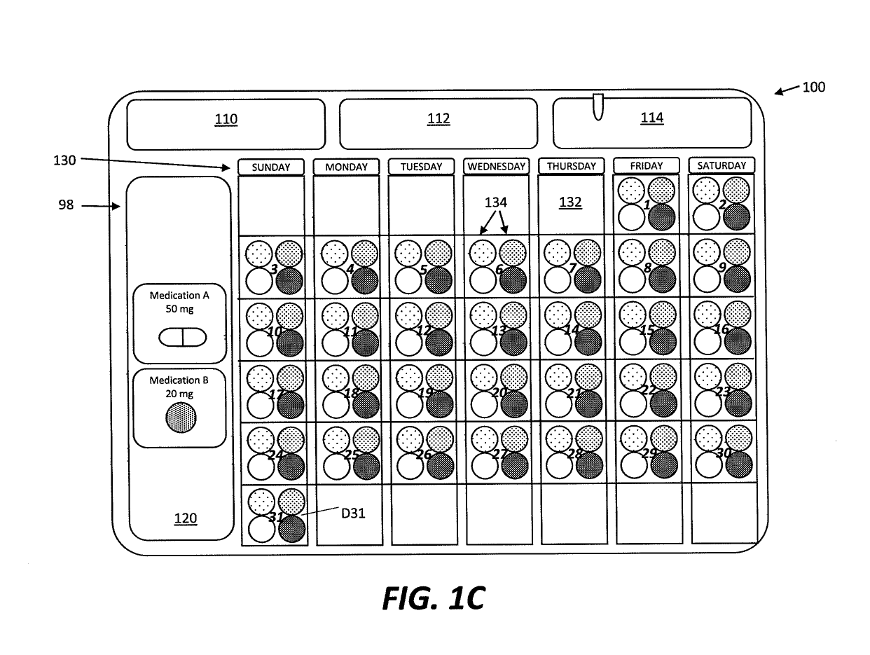

FIG. 1A shows an exemplary embodiment of a user-specific pill dispensary 10, in accordance with aspects of the inventive concept. The pill dispensary 10 includes a backing 100 and a blister sheet 200. As generally described herein, the blister sheet 200 includes an array of cavities 204 (or “blisters” or wells) within which one or more pills can be stored, shown in FIG. 1A from a rear view with an open back for loading pills. Preferably, two or more pills can be stored in a single cavity, when the two or more pills are to be taken at the same time.

The view of the backing 100 in FIG. 1A is of a label side 100A, on which can be printed a graphical framework that organizes the array of cavities in the blister sheet 200 into a calendar format having plural cavity-specific-temporal indicia within a single calendar day for one or more days represented by the calendar format. FIG. 1B shows a closure or adhesive side 100B formed to mate with an open back, or rear face, of the blister sheet 200 to seal the array of cavities 204. Side 100B can include an adhesive to facilitate the mating of the backing 100 to the blister sheet 200 and the sealing of the cavities 204. Adhesive 101 can be omitted or covered over at locations 103 that correspond to locations of the array of cavities 204 of the blister sheet 200.

In various embodiments, the backing 100 and blister sheer 200 may include at least one alignment protrusion or recess/cutout and the backing can include at least one corresponding alignment recess/cutout or protrusion to provide a predetermined mating of the backing 100 with the blister sheet 200. In FIG. 1A, as an example, blister sheet 200 is shown with an alignment protrusion 205 and the backing includes a corresponding alignment cutout 105 configured to mate with the alignment protrusion 205 of the blister sheet when mated. The alignment mechanisms can ensure that the label is properly aligned with the array of cavities for proper dispensing of pills (e.g., medications) stored therein.

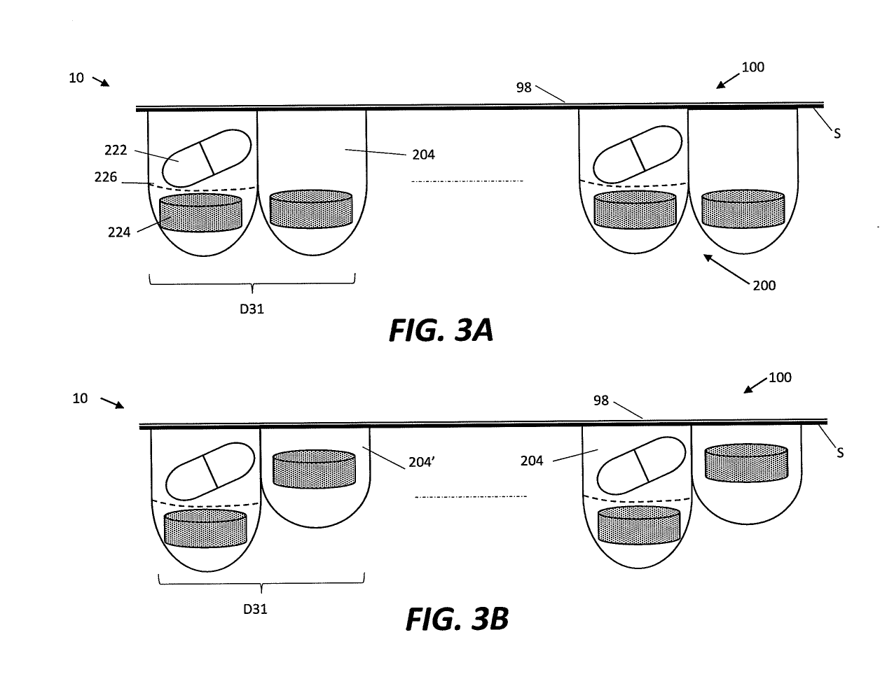

FIG. 1C shows an exemplary embodiment of a graphical framework with content 98 that forms part of the backing 100, in accordance with principles of inventive concepts. In some embodiments, the backing can take the form of a printable sheet that can be run through a printer to obtain some or all of content 98, e.g., a calendar format and cavity-specific-temporal indicia, as well as other relevant information. In such cases, a thin paper or plastic backing could be used to cover the adhesive 101 during printing. In other embodiments, some or all of the content could be printed on a label that can be applied to a backing substrate S (see FIGS. 3A and 3B) to collectively form the backing 100.

In either case, the cavity-specific-temporal indicia can be computer generated and printed, e.g., on a backing label or printable backing sheet. The calendar format could be part of a printable sheet or label before printing thereon the cavity-specific-temporal indicia, and other information. In other embodiments, the calendar format can be printed with the cavity-specific-temporal indicia, and other information, on a blank printable sheet or label.

In the exemplary embodiment of FIG. 1C, a month's supply of pills, e.g., medications, are contained in an associated blister sheet 200, as indicated by the fields of the backing content 98. Fields included in this exemplary embodiment are: user (e.g., patient) information field 110, month and year field 112, pharmacy information field 114, pill information field 120, and calendar formatted field 130. In this embodiment, the layout of the calendar formatted field 130 days and weeks correspond to a month and year shown in field 112. As a result, the content 98 has a true monthly calendar format. For example, in the embodiment shown, the month and year could be August 2014, with August 1^{st} falling on a Friday and August 31^{st} falling on a Sunday. Other embodiments could include different information and fields, which could be differently arranged and formatted.

The user information field 110 can include a patient name and contact information, e.g., phone, address, email address, identification number, date of birth, allergy information (e.g., allergic to eggs), ailment or condition information (e.g., diabetic), emergency contact information, medical insurance information, physician information, and the like, or various combinations and/or subsets thereof. For example, the user information field 110 could additionally include adverse reaction information, other medical history information, or both. In various embodiments, information contained in this field could be for use by the user/patient, a treating or diagnosing healthcare professional, or by a distributing party, such as a pharmacy. As an example, printed patient name and contact information could be used by both a pharmacy to confirm that the medications are directed toward the proper user/patient and by the consuming patient to ensure that the proper person within a household is consuming the medication.

Allergy, adverse reaction, contraindications, and patient history information may be more useful for a pharmacy and could, therefore, be included in a format other than printed language. That is, such information could be included in a machine readable format, such as Universal Product Code (UPC), international article number (EAN), quick response (QR), or other code. The machine-readable codes could contain the information directly or may act as a pointer to a patient file containing the information, for example.

In accordance with principles of inventive concepts, the month and year field 112 may be used to identify the month and, optionally, year within which the pills are intended to be consumed, e.g., according to a patient's prescriptions(s). Including the month within which the pill(s) are to be consumed accommodates changes in prescriptions. For example, some prescriptions are only for a limited time and may only run for a part of a calendar month, according to an effectiveness period or prescribed regimen. A ten-day prescription, with varying dosages throughout the prescription period may be readily accommodated using a calendar-oriented package in accordance with principles of inventive concepts. In such a case, none of the limited-time pills (e.g., medications) would be included in cavities 204 until the date in which the prescription commences, and only for the prescribed period thereafter. If the dosage varies during the ten-day period, using this example, the proper dosage would be put in each cavity 204 according to the prescribed amounts, e.g., tapering the dosage from the first day to the tenth day.

In exemplary embodiments in accordance with principles of inventive concepts, the pharmacy information field 114 may include a pharmacy identification, contact information, and refill numbers, as examples. This field may also include machine-readable printed coding that relates to pharmacy, patient, and/or patient's physician information, as examples.

The pill information field 120 provides information associated with the pill(s) contained within the blister sheet 200, and can include graphical or image representations of such pills, along with a pill's name and dosage. A name and dosage (e.g., in milligrams (mg)) of each pill can be displayed in proximity with the display of the pill image. In this embodiment, an image of a first pill 122, labeled “Medication A,” is provided and an image of a second pill 124, labeled Medication B,” is provided. A dosage amount is also provided for each pill, i.e., 50 mg for Medication A and 20 mg for Medication B. In exemplary embodiments, the pill images 122 and 124 are preferably the same size and/or color as the actual pills (e.g., see pills 222 and 224 in FIGS. 3A-3B) contained within the package 10, whether tablets, capsules, gel caps, lozenges, or other dosage vessel or form.

The pill information field 120 can also include consumption or usage instructions, e.g., “Do not take on an empty stomach”, “Do not take with alcohol,” “Do not operate machinery,” and so on. The pill information field 120 can also include information concerning potential side effects and warnings, e.g., “May cause drowsiness,” “If shortness of breath occurs, consult a physician before continuing use,” and so on.

In exemplary embodiments in accordance with principles of inventive concepts, the calendar formatted field 130 includes a calendar-formatted array of days of the month, e.g., for a particular month represented in the month and year field 112. That is, as illustrated in the exemplary embodiment of FIG. 1C, the array may be a generally rectangular array of seven day columns by six week rows of day fields 132. Including six week rows allows for week segments at the beginning and end of the month, as illustrated by the 1^{st} and 2^{nd} days of the month falling in the first week and the 31^{st} day (D31) of the month falling on the last week, resulting in two different week segments in the calendar-formatted array. As illustrated, the day fields 132 can be arranged, not simply to fill days and columns in a rectangular array, without respect to the calendar, but with empty entries in the rectangular array that represent days of previous or upcoming months. Corresponding cavities 204 of the blister sheet 200 can be left unfilled or the blister sheet itself may be formed to correspond with the particular month, having no cavities formed in the rectangular array where days are absent, for example.

Within each day field 132, there is a set of one or more cavity-specific-temporal indicia (e.g., time-of-day codes 134), with one time-of-day code 134 for each cavity 204 in this embodiment. In other embodiments, a single time-of-day code 134 can be associated with more than one cavity 204 for a single day 132, e.g., if it took more than one cavity to store all of the pills to be taken at the same time for that day. In this embodiment, there are four time-of-day codes 134 in each day field 132. Each time-of-day code 134 indicates a time of day for taking the pills stored in an associated cavity or cavities, e.g., a.m., morning, noon, afternoon, p.m., evening, bedtime, breakfast, snack, lunch, and/or dinner.

In various embodiments, different time-of-day codes 134 can have different visual, graphical, tactile, and/or textual appearances. For example, each different time-of-day code 134 can have a different color, shape, pattern, text, or combinations of two or more thereof. For example, in various embodiments, the time-of-day codes 134 may each have a different color, shading, text, shape, and/or pattern corresponding to the time of day that the pill within the associated cavity or cavities is or are to be taken. As an alternative, or in addition to, different time-of-day codes could include different tactile coding, such as Braille, which is contemplated within the scope of inventive concepts. Empty cavities 204 may be associated with time-of-day codes, for example, in situations where a particular medication is to be taken for only a part of the month or there are no medications indicated for a predefined time of day.

FIG. 1D is a larger view of the 31^{st} day D31 from the calendar formatted field 130 embodiment of FIG. 1C. There are four time-of-day codes 134, one for morning (labeled “morn”), one for noontime (labeled “noon”), one for early evening/dinner time (labeled “eve”), and one for late evening/bedtime (labeled “night”). The date, i.e., “31” is provided in a central location of the day field 132, but it could be otherwise located within the day field 132, or in association therewith in other embodiments.

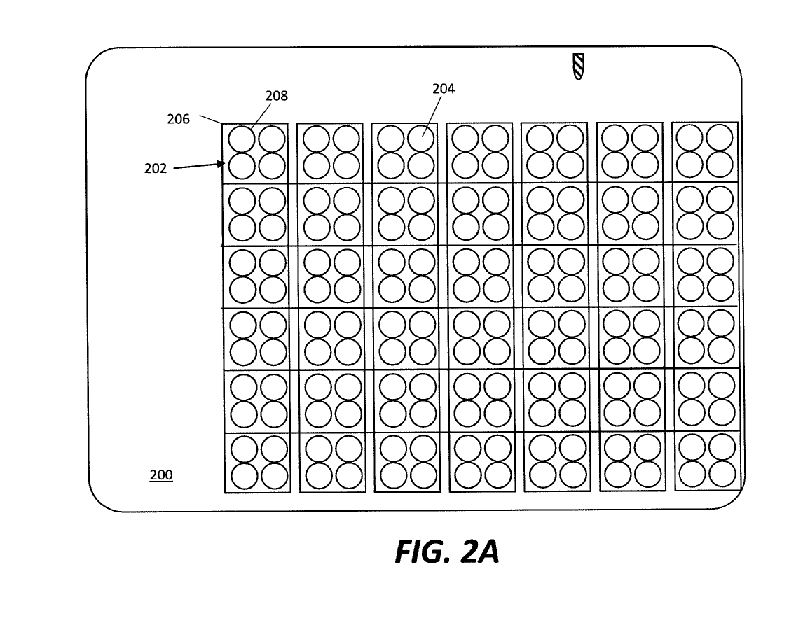

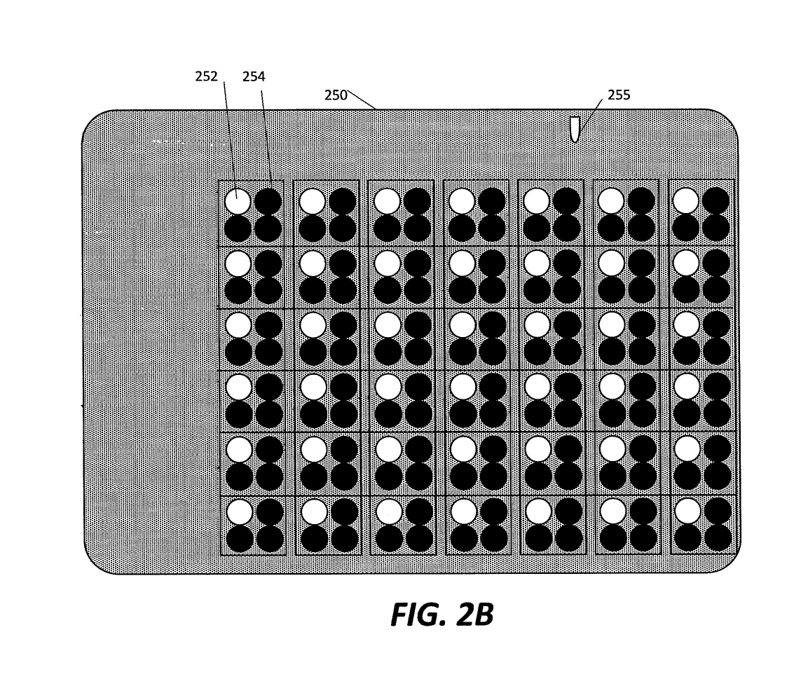

FIG. 2A provides an exemplary embodiment of the blister sheet 200 provided in FIG. 1A, which shows an arrangement or array of cavities (or blisters) formed in the blister sheet 200, in accordance with principles of inventive concepts. In this exemplary embodiment, the blister sheet 200 is arranged in six rows by seven columns of blister day sets 202, with the lowest rightmost blister day field devoid of blisters—such an arrangement will accommodate any monthly configuration of days. Such an arrangement corresponds to the arrangement of day fields 132 and time-of-day codes 134 of the backing 100 of FIG. 1C.

In this exemplary embodiment, each blister day set 202 includes four time-of-day cavities 204, one or more of which can contain a plurality of pills, e.g., two, for holding and dispensing the pills (e.g., medications) up to four times each day, e.g., morning, noon, evening, and night. Each blister day set 202 can optionally be defined by a border region 206 that separates one blister day set 202 from another, and which may be formed for contact with an adhesive layer on an associated printed backing 100, as previously described.

Each time-of-day cavity 204 can optionally have a border region 208 that, similarly, separates one time-of-day cavity 204 from another, and which may be formed for contact with an adhesive layer on an associated backing 100. In exemplary embodiments in accordance with principles of inventive concepts, substantially the entire surface of blister sheet 200, other than regions where time-of-day cavities 204 are formed, may be configured for contact with, and adhesion to, an adhesive layer or side of backing 100, as shown in FIG. 1B.

FIG. 2B is an embodiment of a blister sheet loading template 250, in accordance with principles of the inventive concepts. Loading template 250 can be arranged to temporarily mate with the blister sheet and to include openings 252 used to reveal or expose only cavities 204 corresponding to a specific time-of-day code, to enable more accurate and faster loading of the cavities 204. Loading template 250 may also include cavity covers 254 that block cavities 204 corresponding to other time-of-day codes. Loading template 250 can optionally also include a cutout 255 configured to receive alignment protrusion 205 to assist in properly aligning openings 252 with appropriate cavities 204.

Other embodiments of loading templates are also contemplated. Loading templates can be user-specific—that is, specifically formed for the user's pill requirements, as representing in the content design of the backing. Loading templates could also be pills specific, including openings for each cavity that is to receive a specific pill, even if that pill was to be used for less than a full month (or week) of for multiple or different time-of-day codes for the given calendar format.

FIG. 3A shows a partial side view of an embodiment of a pill dispensary 10. As discussed, each blister cavity 204 can be formed to hold a plurality of pills, which may or may not be allowed to contact. In this embodiment, pill 222 corresponds to pill image 122 of FIG. 1C and pill 224 corresponds to pill image 124 of FIG. 1C. In the side view of FIG. 3A, two cavities 204 can correspond to day 31 (D31) in the calendar represented in FIG. 1C. The left cavity represents “evening” and the right cavity 204 represents “night” from FIG. 1C. Here, pill 222 is indicated to be taken in the “evening,” while pill 224 is indicated is indicated to be taken in the “evening” and at “night,” e.g., which preferably conforms to dosage and/or prescription requirements.

In some embodiments, an insertable divider 226 can be included within the cavity 204 to prevent contact between the pills 222, 224, as shown. The divider 226 could be a small piece of paper, foil, plastic, cotton, or the like that separates pills in the same cavity. A blister cavity can be separated or sealed off from other blister cavities by an adhesive seal between the two, e.g., provided by adhesive from the backing 100, for example.

The embodiment of FIG. 3B is similar to that of FIG. 3A, but demonstrates that all cavities 204, 204′ need not be the same size. Differences in sizes between cavities 204, 204′ could depend on the size and/or volume requirements of the pill(s) to be stored in the cavities 204, 204′.

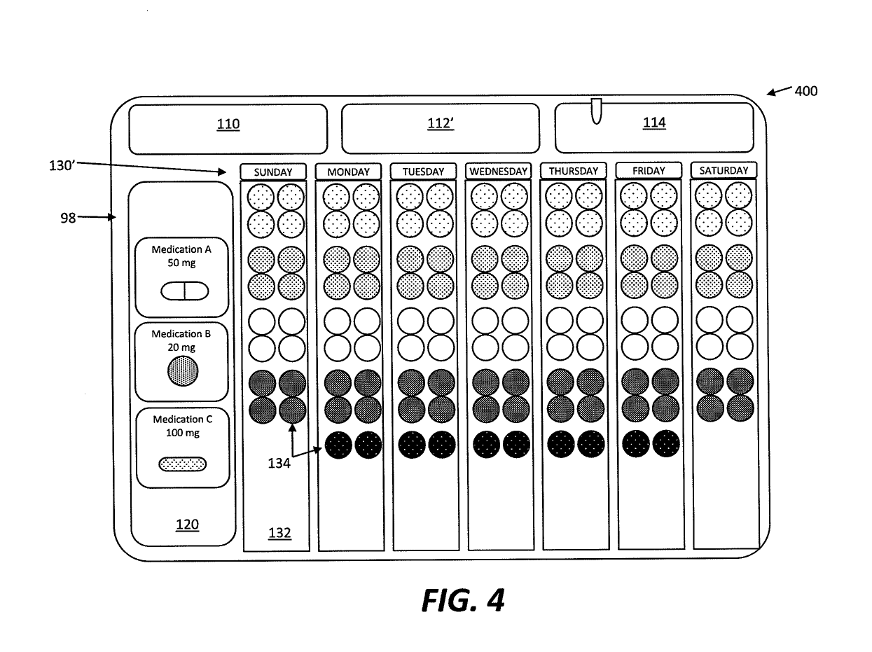

Other backing configurations and embodiments are contemplated within the scope of inventive concepts. For example, as illustrated in FIG. 4, a person having multitude prescriptions can be accommodated by a weekly pill dispensary having a calendar formatted backing 400 different than backing 100 of FIG. 1C. Backing 400, similar to backing 100, includes a graphical framework that organizes the array of cavities into a calendar format having plural cavity-specific-temporal indicia. And backing 300 can be configured for use with blister sheet 200 of FIGS. 1A and 2B, in some embodiments. In other embodiments, the blister sheet can have a blister sheer with a differently configured array of cavities. In any case, the day fields 132 and time-of-day codes 134 of backing 400 must properly align with cavities of a corresponding blister sheet.

In this form, each day of the week represents a column comprising an array of cavities 204, each cavity is configured to hold one or more pills, as discussed above. Within each day of the week column, there may be one or more cavities associated with one or more different times of day that pills are to be taken.

As with the exemplary backing 100 embodiment of FIG. 1C, backing 400 can include fields for the patient information 110, the week (and optionally month and/or year) field 112′, a pharmacy information field 114, a pill information field 120, and a calendar formatted field 130′. The week (and optionally month and/or year field) 112′ can be used to identify a week corresponding to the pills stored in the cavities of the blister sheet. Preferably, a month or date range is also provided in field 112′, in various embodiments. Optionally, the year can also be provided in various embodiments. Other fields can contain information as described herein above with respect to backing 100.

In this exemplary embodiment, backing 400 provides only one week's supply of pills, with each day represented by a column (or day field 132), as shown in calendar formatter field 130′. In this embodiment, each day column/field 132 includes a plurality of time-of-day codes 134. In this embodiment, four sets of time-of-day codes 134 are provided, e.g., morning, noon, evening, night, with a plurality of instances of each time-of-day code 134, four in this exemplary embodiment.

In FIG. 4, a third medication is shown, Medication C, 100 mg. And additional time-of-day code 134 is shown that only spans five days, e.g., a 5-day antibiotic regimen taken once a day (e.g., at midnight). Each time-of-day code is represented with different shading in this embodiment, and may also include time-of-day coding text, color, and/or shape differences, such the text shown in FIG. 1D.

In an exemplary embodiment such as this, each time-of-day code 134 may be associated with a specific cavity or cavities that each contains one or more pills. In other embodiments, a single time-of-day code 134 can be associated with a plurality of cavities, each containing one or more pills (e.g., medications) to be taken at the time indicated by the time-of-day code 134.

In various embodiments, a user (e.g., a patient) can open a blister of cavity 204, for example, by pressing the pill from the blister side through the backing 100, 400. In this embodiment, four time-of-day codes 134 at each dispensing period (e.g., morning, noon, evening, night) of day of the week are provided. As previously indicated, an opened blister cavity 204 provides both visual and tactile feedback indicating that the particular pill or pills associated with a blister cavity 204 has been removed. Conversely, if the blister cavity 204 has not been opened, visual and tactile feedback is available that indicates that the associated medications remain to be consumed.

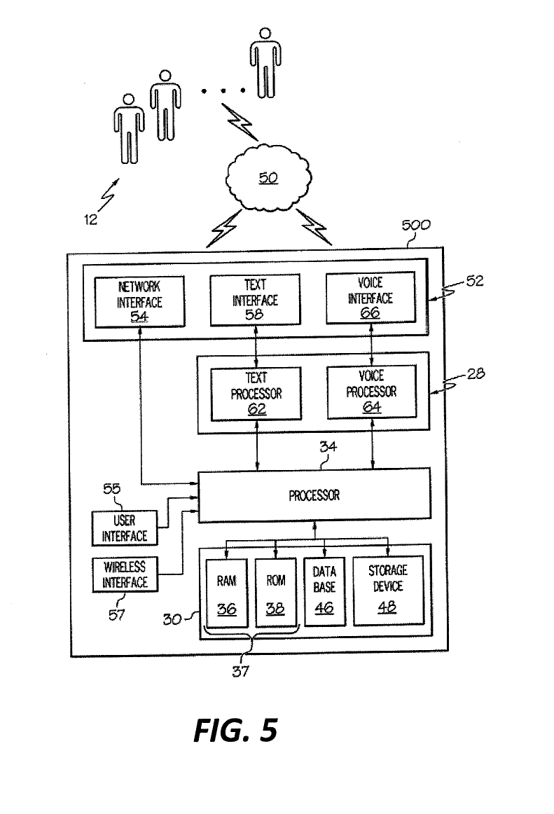

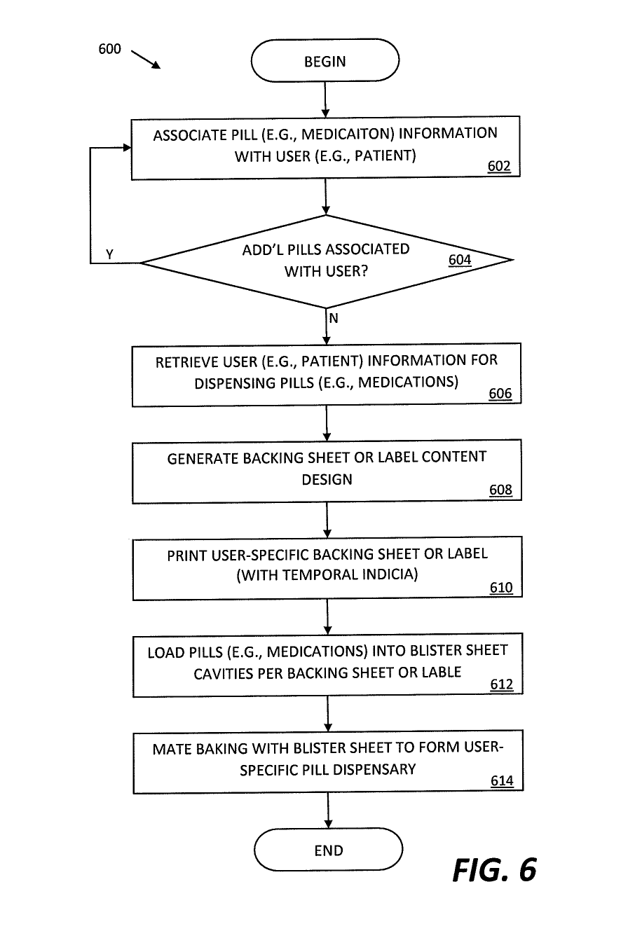

FIG. 5 is an exemplary block diagram of a processing system 500 with which at least a portion of the implementation of a user-specific pill dispensary system in accordance with principles of inventive concepts may be implemented. The flow chart of FIG. 6 describes a process that may be employed in conjunction with the processing system 500 to implement such a user-specific pill dispensary system, in accordance with principles of inventive concepts. The processing system can include in a personal digital assistant (PDA), a cell phone, a computer, a laptop, a tablet, a terminal, or any other suitable electronic device, whether wired or wireless, for example. The processing system 500 includes at least one processor 34 (e.g., a central processing unit (CPU)) that stores and retrieves data from an electronic information (e.g., data) storage system 30. As will be appreciated by those skilled in the art, while processing system 500 is shown with a specific set of components, various embodiments may not require all of these components and could include more than one of the components that are included, e.g., multiple processors. It is understood that the type, number, and connections among and between the listed components are exemplary only and not intended to be limiting.

In the illustrative embodiment, processor 34 is referred to as CPU 34, which may include any of a variety of types of processors known in the art (or developed hereafter), such as a general-purpose microprocessor, a bit-slice processor, a digital signal processor or a microcontroller, or a combination thereof, for example. CPU 34 may be operably coupled to storage systems 30 and configured to execute sequences of computer program instructions to perform various processes and functions associated with the prescription dispensing system, including the storing, processing, formatting, manipulation and analysis of data associated with the prescription dispensing system (for example, patient history, patient prescriptions, potential interactions etc.). The computer program instructions may be loaded into any one or more of the storage media depicted in storage system 30, which may include non-transitory storage media.

Storage system 30 may include any of a variety of semiconductor memories 37, such as, for example, random-access memory (RAM) 36, read-only memory (ROM) 38, a flash memory (not shown), or a memory card (not shown). The storage system 30 may also include at least one database 46, at least one storage device or system 48, or a combination thereof. Storage device 48 may include any type of mass storage media configured to store information and instructions that processor 34 may need to perform processes and functions associated with the prescription dispensing system. As examples, data storage device 48 may include a disk storage system or a tape storage system. A disk storage system may include an optical or magnetic storage media, including, but not limited to a floppy drive, a zip drive, a hard drive, a “thumb” drive, a read/write CD ROM, or other type of storage system, media, or device. A tape storage system may include a magnetic, a physical, or other type of tape system.

While the embodiment of FIG. 5 shows the various storage devices collocated, they need not be, as they could be remote to each other, to processor 34 or both. Storage system 30 may be maintained by a third party, may include any type of commercial or customized database 46, and may include one or more tools for analyzing data or other information contained therein. In particular, database 46 may correspond, all or in part, to a patient information and/or medical information database, and may include tools for obtaining such information from other data storage systems for inclusion on the printable backing, label, etc., as previously described.

In various embodiments, data storage system 30 may be configured to store data representative of users (e.g., patients, healthcare providers, insurance companies, etc.) 12. Data representative of users 12 may include data that is not specific to the user-specific pill dispensary system, such as a name, a delivery address, a zip code, a credit card number, a social security number, insurance information, a phone number, an email address, or a combination thereof, as examples. Data representative of a user may include data associated with the user and the user-specific pill dispensary system, such as, prescribing physician and preferred pharmacy outlet, for example.

As an example, database 46 may include any hardware, software, or firmware, or any combination thereof, properly configured to store data, such as computer data. Specifically, database 46 may be configured to store data and information representative of one or more of the plurality of users 12, their prescriptions, and other information. In some embodiments, database 46 may include one or more fields, wherein a field may be an element of a database record in which one piece of information may be stored. In particular, a field may be configured to store an element of data representative of one or more of the users 12.

In some embodiments, one or more storage device in the data storage system 30 (e.g., database 46) may be configured to store prescription, medication, or other data associated with the user-specific pill dispensary system. Data associated with the user-specific pill dispensary system may be stored in storage system 30 using any suitable database format, such as, for example, a relational database, a hierarchical database, or any suitable schema. Data storage system 30 may be configured to store information in a format configured to enhance operations of CPU 34 or other functions of the user-specific pill dispensary system.

Processing system 500 may include or interface with one or more security systems (not shown), configured to at least partially restrict or control access to one or more components of processing system 500. Security systems may include hardware, software, firmware or a combination thereof, such as, for example, a firewall, password protection software, user authentication software, encryption software and the like. In some embodiments, security systems may be configured to limit a function of the user-specific pill dispensary system, limit access to data associated the user-specific pill dispensary system, or both.

In some embodiments, processing system 500 may be configured so that select data contained within storage system 30 may be inaccessible to one or more of the users 12.

Processing system 500 may include a network interface system or subsystem 54 configured to enable medication, prescription, patient, or other data updates, for example. As such, processing system 500 may be configured to transmit or receive, or both, one or more signals related to the functions of the user-specific pill dispensary system. A signal may include any generated and transmitted communication, such as, for example, a digital signal or an analog signal. As examples, network 50 may be a local area network (LAN), wide area network (WAN), virtual private network (VPN), the World Wide Web, the Internet, voice over IP (VOIP) network, a telephone or cellular telephone network or any combination thereof. The communication of signals across network 50 may include any wired or wireless transmission paths. The user-specific pill dispensary system previously described may employ the one or more networks 50, for example.

To enable communications via network 50, processing system 500 may include a set of interfaces 52 and a set of processors 28, as well as processor 34. The set of processors 28 may include a text processor 62 and a voice processor 64, along with CPU 34. The set of interfaces may include a network interface 54, a text interface 58 and a voice interface 66, as shown in this embodiment. As mentioned above, network 50 may represent a combination of networks configured to transmit and receive communications with processing system 500, via any of the set of interfaces 52.

CPU 34 may be operably coupled to network interface system 54 for exchanging typical computer network information, e.g., via the Internet, a LAN, WAN, VPN or some combination thereof. Network interface system 54 may be configured to permit communication between and among the users 12 and processing system 500, for example using an Internet protocol (IP) or other network-based protocol. In such cases, network interface system 54 may be configured to utilize TCP/IP, HTTP, DNS or any other application, transport, network, or link protocol, or combination of the foregoing.

Text interface 58 may be operably coupled to a text processor 62 configured to process received text message and text messages to be transmitted. Text interface 58 may be configured to permit text-based communication between users 12 and processing system 500. For example, in combination, text interface 58 and text processor 62 may include functionality to communicate with a two-way pager, a personal digital assistant (PDA), a cell phone, a computer, a laptop, a tablet, a terminal, or any other suitable electronic device, including a printer, whether wired or wireless. Text processor 62 may include an email system configured to transmit, receive, or process, email messages or a combination thereof. Text processor 62 may also include an instant-messaging (IM) system, a two-way paging system or other system configured to transmit, receive, or process, or a combination thereof, text-based information. As will be appreciated by those skilled in the art, such systems may also provide mechanisms for transferring files between devices. Such files may include any of a wide variety of content.

Voice interface 66 may be operably coupled to a voice processor 64 configured to process received voice information and voice data to be transmitted. Voice interface 66 may be configured to permit voice-based communication between and among the users 12 and processing system 500. For example, in combination, voice interface 66 and voice processor 64 may be configured to enable interaction with a cell phone, a fixed-line telephone, a VOIP device or other similar device, or combinations thereof. For example, voice interface 66 may be configured to transmit, receive, or digital or analogue signals using wired to wireless communications devices and systems, such systems can include telephone, cellular telephone and VOIP systems, as examples.

In some embodiments, the operable connections between components of processing system 500 may be other than as shown in FIG. 5. For example, data storage system 30 may be operably connected to communication processors 28 or interfaces 52, or both, such that users from the plurality of users 12 may modify data stored in data storage system 30 using such interfaces and processors. User interface 55, which may include one or more displays, including touch-screen displays, for example, may also include keypad, button, or other input devices, including, in some exemplary embodiments, voice interface 66. User interface may be in addition to network interface 50, for example. Wireless interface may include various technologies, such as Bluetooth technologies that permit a user and/or a prescription dispensing system to communicate with other devices including navigational devices, for example, and may be in addition to network interface 54.

In various embodiments, systems that may be associated with the user-specific pill dispensary system may include one or more systems configured to provide additional functions associated or useful in conjunction with the medication dispensing system. For example, systems associated with the user-specific pill dispensary system may include a medical network system to directly accept and confirm prescriptions from a physician's office, a clinic, or hospital, for example, an insurance system for payment of medications, medication information systems for information concerning costs, availability, warnings, guidelines, and so on associated with medications.

It is also contemplated that the user-specific pill dispensary system could be implemented using one or more processing systems 500, as described above. For example, various embodiments of a user-specific pill dispensary system could include a plurality of processing systems 500, components of processing system 500, or other systems associated with the user-specific pill dispensary system. Heavy usage may, for example, require relatively high computational power to efficiently operate the user-specific pill dispensary system.

The flow chart of FIG. 6 depicts an exemplary embodiment of method of providing user-specific pill dispensary, in accordance with principles of inventive concepts. In this embodiment, the user can be a patient and the pills can be, or include, medications, for illustrative purposes. At least a portion of the method can be executed by a processor, such as the one described in the discussion related to FIG. 5. For example, system 500 can be used to generate a content design for the backing, including generating a design of the information in sections 110, 112 (or 112′), 114, 130 (or 130′), including 134 and 132 as described herein. Some or all of the content (e.g., content 98) can be printed in a backing sheet or label, according to a computer-generated design.

In this exemplary embodiment, the process begins and proceeds to step 602 where one or more pill order, such as a medication prescription, is associated with a user (e.g., patient), e.g., by a computer system. Such an association may entail a processor's storage of medication information (medication image, dosage, temporal consumption information such as, for example, the time of day the patient is to take the medication, the date the patient should begin taking the medication, termination of the medication, etc.) within a patient file. After associating a medication with a patient in step 602, the process proceeds to step 604 where it is determined, by a processor, for example, whether any additional medications are to be associated with the patient. If there is an indication that the patient has additional medications, the process returns to step 602 and proceeds from there.

If the patient has no additional medications, the process proceeds from step 604 to step 606, where patient information is retrieved to prepare a user-specific pill dispensary design, such as discussed with content 98 and backings 100 and 400 above. Design generation of the pill dispensary occurs in step 608. The design can include, for example, selection of an appropriate blister sheet for use with the printed user-specific backing sheet or label that will be generated. That is, although exemplary embodiments have shown blister sheets having the same layout, which may be customized for monthly or weekly consumption or dispensing plans, for example, other blister sheet layouts are contemplated within the scope of inventive concepts. Additionally, the design can include selection of a backing or backing template, providing some constraints or general format for the design, such as a preprinted framework that can be populated with user-specific information. That is, the design of the backing layout and content includes the design and arrangement of user (or patient)-specific content, as described in greater detail above.

From step 608 the process proceeds to step 610, where the user-specific backing sheet or label designed in step 606 is printed. The backing, according to its design, includes a graphical framework that organizes the array of cavities of the blister sheer into a calendar format having plural cavity-specific-temporal indicia within a single calendar day for one or more days represented by the calendar format. In accordance with principles of inventive concepts, such printing may be performed at any of a variety of locations, and by any known types of printers (e.g., a laser printer, an ink jet printer, etc.). For example, the backing sheet or label may be printed at a local pharmacy, clinic, physician's office, or at a centralized pharmaceutical distribution location, medical information location, healthcare provider location, or insurance provider location, and so on.

In step 612, blister sheet cavities are loaded with the appropriate pills (e.g., medications) in a manner that corresponds to an associated user-specific backing. That is, pills, which may be prescribed or available over-the-counter, are placed within the appropriate cavities 204, 204′ to correspond with temporal indicia printed on the backing.

In step 614, a printed backing is mated with a corresponding blister sheet to form a user-specific pill dispensary. If the content was printed on a backing label, the backing label can be applied or adhered to a backing substrate to complete the backing, before mating the backing with the filled blister sheet. The process can then proceed to end.

In various embodiments, the computer-implemented method can also include, optionally, generation of loading templates to assist in properly loading an array of cavities of blister sheets.

Although exemplary embodiments have been described with regard to the use of blister packs, other packaging forms are contemplated within the scope of inventive concepts, each employing user-specific and/or user-tailored packaging. Although blister packs are commonly designed to be opened by pushing the content from the blister side through the “paper” or foil side, inventive concepts are not limited thereto; blisters may include frangible lines or removable seals to facilitate opening of the blister side of the pack, for example.

Delivery of medications, whether prescription or non-prescription or a combination of both, are contemplated within the scope of inventive concepts, but such concepts are not limited to medications. In the case of medications, whether prescription or non-prescription, patient-tailored medication packaging in accordance with principles of inventive concepts include cavities for one or more patient-specific medications and indicia, such as a calendar-formatted backing, that provide a patient with guidance for taking medications and, by virtue of openings in the packaging or, simply, the absence of medication in a temporal-coded cavity, an indication that a medication has been consumed. Although exemplary embodiments include a single time-of-day code associated with a single cavity, the inventive concepts are not limited thereto; each time-of-day code can have more than one cavity associated with it.

While the present inventive concepts have been particularly shown and described above with reference to exemplary embodiments thereof, it will be understood by those of ordinary skill in the art, that various changes in form and detail can be made without departing from the spirit and scope of inventive concepts as defined by the following claims.

What is claimed is:

1. A user-specific pill dispensary, comprising:
a blister sheet having an array of cavities formed therein, including cavities formed to contain user-specific pills; and
a backing configured to seal the array of cavities, the backing including a graphical framework that organizes the array of cavities into a calendar format having plural cavity-specific-temporal indicia within a single calendar day for one or more days represented by the calendar format.

2. The dispensary of claim 1, wherein one or more of the cavities is configured to individually hold plural pills having the same cavity-specific-temporal indicia.

3. The dispensary of claim 1, wherein the backing is a foil-back sheet including an adhesive that mates with an open back of the blister sheet.

4. The dispensary of claim 1, wherein the calendar format represents a single week or a single month.

5. The dispensary of claim 1, wherein the calendar format includes a plurality of day fields arranged in columns.

6. The dispensary of claim 1, wherein the plural cavity-specific-temporal indicia includes at least two different time-of-day indicia, including two or more of a.m., morning, noon, afternoon, p.m., evening, bedtime, breakfast, snack, lunch, and dinner.

7. The dispensary of claim 6, wherein each of the at least two time-of-day indicia has a different visual appearance.

8. The dispensary of claim 7, wherein the different visual appearance includes, for each different time-of-day indicia:
color coding;
different shapes;
different patterns; or
combinations of two or more of the above.

9. The dispensary of claim 1, wherein the calendar format is viewable through the blister sheet.

10. The dispensary of claim 1, wherein the calendar format is viewable from a rear face of the backing, opposite the blister sheet.

11. The dispensary of claim 1, wherein the backing further comprises pill information for one or more pills contained within a cavity of the blister sheet, the pill information including:
a graphical representation of the one or more pills;
a dosage amount of the one or more pills; or
graphical representation and dosage amount of the one or more pills.

12. The dispensary of claim 11, wherein the pill information further includes one or more of:
side effect information for the one or more pills;
warnings for the one or more pills;
usage instructions for the one or more pills; or
combinations of two or more of the above.

13. The dispensary of claim 1, wherein the backing further includes user-specific information, including:
patient name;
a patient address;
a patient identification number;
a patient date of birth;
patient allergy information;
patient aliment or condition information;
emergency contact information;
patient medical insurance information;
prescribing physician information;
dispensing pharmacy information; or
combinations of two or more of the above.

14. The dispensary of claim 1, wherein the backing includes a patient-specific printable label on which the graphical framework is electronically printed.

15. A user-specific pill dispensary, comprising:
a blister sheet having an array of cavities formed therein, each cavity containing one or more user-specific pill, at least one cavity containing a plurality of pills having common temporal indicia; and
a backing sealing the array of cavities, the backing including a graphical framework that organizes the array of cavities into a calendar format having plural cavity-specific-temporal indicia within a single calendar day for one or more days represented by the calendar format.

16. The dispensary of claim 15, wherein the plural cavity-specific-temporal indicia includes at least two different time-of-day indicia, including two or more of a.m., morning, noon, afternoon, p.m., evening, bedtime, breakfast, snack, lunch, and dinner.

17. The dispensary of claim 15, wherein each of the at least two time-of-day indicia has a different visual appearance, including for each different time-of-day indicia:
color coding;
different shapes;
different patterns; or
combinations of two or more of the above.

18. A method of preparing a user-specific pill dispensary, comprising:
providing a blister sheet having an array of cavities formed therein, each cavity formed to receive one or more user-specific pills;
preparing a backing configured to seal the array of cavities, including printing the backing to include a graphical framework that organizes the array of cavities into a calendar format having plural cavity-specific-temporal indicia within a single calendar day for one or more days represented by the calendar format;
filling the array of cavities with the one or more user-specific pills according to the calendar format and the cavity-specific-temporal indicia; and
applying the backing to the blister sheet to seal the array of cavities and transform the blister sheet into a sealed pills dispensary having the one or more pills organized according to the calendar format and the cavity-specific temporal indicia.

19. The method of claim 18, wherein the plural cavity-specific-temporal indicia includes at least two different time-of-day indicia including two or more of a.m., morning, noon, afternoon, p.m., evening, bedtime, breakfast, snack, lunch, and dinner.

20. The method of claim 18, wherein each of the at least two time-of-day indicia has a different visual appearance, including for each different time-of-day indicia:
color coding;
different shapes;
different patterns; or
combinations of two or more of the above.
